(19) United States
(12) Patent Application Publication
(10) Pub. No.: US 2018/0084799 A1
(43) Pub. Date: Mar. 29, 2018

(54) FAT AND/OR OIL COMPOSITION FOR HEAT COOKING AND METHOD OF PREPARING SAME, AND METHOD OF PREVENTING DETERIORATION OF FAT AND/OR OIL FOR HEAT COOKING CAUSED BY HEATING

(71) Applicant: The Nisshin OilliO Group, Ltd., Tokyo (JP)

(72) Inventors: Yoshihiro MURANO, Tokyo (JP); Reiko EJIRI, Tokyo (JP); Takahide WATANABE, Tokyo (JP); Kanji AOYAGI, Tokyo (JP)

(73) Assignee: The Nisshin OilliO Group, Ltd., Tokyo (JP)

(21) Appl. No.: 15/716,780

(22) Filed: Sep. 27, 2017

(30) Foreign Application Priority Data
Sep. 29, 2016 (JP) 2016-192106

(51) Int. Cl. A23D 9/013

(52) U.S. Cl. CPC A23D 9/013; C07F 1/00

(57) ABSTRACT

A fat and/or oil composition for heat cooking and a method of preparing the same are provided. The fat and/or oil composition includes: a fat and/or oil; a fatty acid monoglyceride; and an alkali metal, wherein a content of the fatty acid monoglyceride is from 0.01 to 1.0 mass %, and a content of the alkali metal is from 0.1 to 5.0 mass ppm. Also provided is a method of preventing deterioration of a fat and/or oil for heat cooking that is caused by heating, the method including: adding, to the fat and/or oil for heat cooking, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil.

### TECHNICAL FIELD

The Present disclosure relates to a fat and/or oil composition for heat cooking and a method of preparing the same, and a method of preventing deterioration of a fat and/or oil for heat cooking that is caused by heating.

### BACKGROUND

In supermarkets, eating places, and restaurants, commercially used fats and oils for heat cooling are often employed to heat-cook a large volume of fried foods at high temperature for a long period of time, and these fats and oils undergo quick deterioration. The deterioration of fats and oils in turn adversely affects taste and appearance of the fried foods. These fats and oils therefore need to be disposed and replaced in a short period of time. However, since this poses economic and environmental burdens, a technology of preventing the deterioration in fats and oils for heat cocking is needed.

An “acid value” may serve as an index of the deterioration of such a fat and/or oil for heat cooking that is caused by heat cooking. The acid value indirectly represents the amount of a free fatty acid produced by hydrolysis, oxidization, or the like of a fat and/or oil. For example, Patent Literature 1 listed below describes a technology of preventing an increase in acid value of a fat and/or oil that is caused by heating, by adding one or more chemical components selected from sodium and potassium in an amount of from 0.1 to 1 μmol/g of the fat and/or oil. Additionally, other indices of the deterioration of a fat and/or oil for heat cocking than the acid value may include a color and a polymer. It is to be noted that preventing an increase in acid value does not translate to prevention of an increase in coloring and polymer production.

Meanwhile, fried foods, such as fries, tempura, and fried chicken called karaage, which include batter coatings, tend to absorb more oil than stir-fried objects. Accordingly, there are demands for reducing the amount of oil to be absorbed in these fried foods more efficiently, while maintaining a satisfactory taste and flavor. To address the above demands, Patent Literature 2 listed below describes that the amount of oil remaining in the cooked objects may be reduced by using a fat and/or oil composition for heat cooking in which an emulsifying agent is added, wherein the emulsifying agent is selected from a glyceryl monooleate succinate, a glyceryl monooleate citrate, a polyoxyethylene sorbitan monooleate, a sucrose erucic acid ester, and a fatty acid monoglyceride in which a constituent fatty acid contains 47% by mass or more of a polyunsaturated fatty acid.

### CITATION LIST

### Patent Literatures

PTL 1: Japanese Patent No. 4798310
PTL 2: Japanese Patent Application Publication No. 2015-119665

### SUMMARY

The acid value, that the aforementioned Patent Literature 1 is to solve, may be useful as an index of the deterioration of a fat and/or oil for heat cooking that is caused by heating. However, the acid value is difficult to measure on-site during heat cooking, and, in many cases, the coloring of a fat and/or oil for heat cooking is used as an index of the deterioration caused by heating.

On the other hand, the technology described in the aforementioned Patent Literature 1 is not considered to sufficiently prevent the coloring of a fat and/or oil that is caused by heating. Furthermore the present inventors have studied a fat and/or oil composition for heat cooking in which the emulsifying agent defined and described in the aforementioned Patent Literature 2 and found that there is still room for improvement in terms of the coloring of a fat and/or oil that is caused by heating.

Accordingly, the present disclosure relates to a fat and/or oil composition for heat cooking that prevents the coloring caused by heating and a method of preparing the same, and a method of preventing the deterioration of a fat and/or oil for heat cooking that is caused by heating.

Features of the present disclosure for solving the above problems are summarized as follows.

One of aspects of the present disclosure resides in a fat and/or oil composition for heat cooking, the fat and/or oil composition including: a fat and/or oil; a fatty acid monoglyceride; and an alkali metal, wherein a content of the fatty acid monoglyceride is from 0.01 to 1.0 mass %, and a content of the alkali metal is from 0.1 to 5.0 mass ppm.

The fat and/or oil composition for heat cooking according to the present disclosure prevents the coloring caused by heating.

In a preferred embodiment of the fat and/or oil composition for heat cooking according to the present disclosure, a constituent fatty acid in the fatty acid monoglyceride contains 60 mass % or more of an unsaturated fatty acid having 18 carbon atoms.

In another preferred embodiment of the fat and/or oil composition for heat cooking according to the present disclosure, the fat and/or oil composition further includes: a fatty acid diglyceride, wherein a mass ratio between the fatty acid monoglyceride and the fatty acid diglyceride is from 1:1 to 7:3.

In yet another preferred embodiment of the fat and/or oil composition for heat cooking according to the present disclosure, the fat and/or oil composition for heat cooking is for use in frying.

In yet another preferred embodiment of the fat and/or oil composition for heat cooking according to the present disclosure, the fat and/or oil composition for heat cooking is used in frying to prevent coloring caused by heating.

Another aspect of the present disclosure resides in a method of preparing a fat and/or oil composition for heat cooking, the method including: refining a fat and/or oil and subsequently adding, to the refined fat and/or oil, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil composition.

With the method of preparing a fat and/or oil composition for heat cooking according to the present disclosure, a fat and/or oil composition for heat cooking that prevents the coloring caused by heating is prepared.

In a preferred embodiment of the method according of preparing a fat and/or oil composition for heat cooking, a constituent fatty acid in the fatty acid monoglyceride contains 60 mass % or more of an unsaturated fatty acid having 18 carbon atoms.

In another preferred embodiment of the method according of preparing a fat and/or oil composition for heat cooking, the method further includes: adding a fatty acid diglyceride to the refined fat and/or oil, wherein a mass ratio between the fatty acid monoglyceride and the fatty acid diglyceride is from 1:1 to 7:3.

In yet another preferred embodiment of the method according of preparing a fat and/or oil composition for heat cooking, as an ingredient containing both fatty acid monoglyceride and the ingredient containing an alkali metal that are to be added to the refined fat and/or oil, a fatty acid monoglyceride containing an alkali metal is used.

Yet another aspect of the present disclosure resides in a method of preventing deterioration of a fat and/or oil for heat cooking that is caused by heating, the method including: adding, to the fat and/or oil for heat cooking, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil for heat cooking.

The method of preventing deterioration of a fat and/or oil for heat cooking that is caused by heating prevents the coloring of the fat and/or oil for heat cooking that is caused by heating.

In a preferred embodiment of the method of preventing deterioration of a fat and/or oil for heat cooking that is caused by heating according to the present disclosure, a constituent fatty acid in the fatty acid monoglyceride contains 60 mass % or more of an unsaturated fatty acid having 18 carbon atoms.

In another preferred embodiment of the method of preventing deterioration of a fat and/or oil for heat cooking that is caused by heating according to the present disclosure, the method further includes: adding a fatty acid diglyceride to the fat and/or oil for heat cooking, wherein a mass ratio between the fatty acid monoglyceride and the fatty acid diglyceride is from 1:1 to 7:3.

In yet another preferred embodiment of the method of preventing deterioration of a fat and/or oil for heat cooking that is caused by heating according to the present disclosure, as an ingredient containing both the fatty acid monoglyceride and the ingredient containing an alkali metal that are to be added to the fat and/or oil for heat cooking, a fatty acid monoglyceride containing an alkali metal is used.

The present disclosure provides a fat and/or oil composition for heat cooking that prevents the coloring caused by heating and a method of preparing the same. The present disclosure also provides a method of preventing the deterioration of a fat and/or oil for heat cooking that is caused by heating that actually prevents the coloring caused by heating.

### DETAILED DESCRIPTION

The present inventors have found that coloring caused by heating may be prevented even under harsh use conditions, such as use conditions of a commercially used fat and/or oil employed in fry cooking, of high temperature for a long period of time, by adding a fatty acid monoglyceride and an alkali metal to the fat and/or oil. Based on the above discovery, the present inventors have completed a fat and/or oil composition for heat cooking and a method of preparing the same, and a method of preventing deterioration of a fat and/or oil for heat cooking that is caused by heating according to the present disclosure.

The following describes the fat and/or oil composition for heat cooking and the method of preparing the same, and the method of preventing deterioration of a fat and/or oil for heat cooking that is caused by heating according to the present disclosure in detail by illustration based on embodiments of the present disclosure. In the embodiments of the present disclosure, from A (a numerical value) to B (another numerical value) means A or more and B or less.

<Fat and/or Oil Composition for Heat Cooking>
(Fat and/or Oil)

The fat and/or oil composition for heat cooking according to the present disclosure contains a typical fat and/or oil for heat cooking as a main component. Such a typical fat and/or oil for heat cooking may include an animal fat and a vegetable oil that are commonly used for heat cooking, and a hydrogenated oil, a fractionated oil, and a transesterified oil of the animal fat and the vegetable oil. These fats and oils may be used alone or in a combination. Examples of the animal fat and the vegetable oil may include a soybean oil, a rapeseed oil, a high oleic rapeseed oil, a sunflower oil, a high oleic sunflower oil, an olive oil, a safflower oil, a high oleic safflower oil, a corn oil, a cotton seed oil, a rice bran oil, a sesame oil, a grape seed oil, a peanut oil, beef tallow, a milk fat, a fish oil, a coconut oil, a palm oil, and a palm kernel oil. Fats and oils that are in a liquid state at a temperature of 20° C. are preferable, because those solidifying at room temperature need to be liquefied by heating for use. Any material fats and oils, which are in the solid state at a temperature of 20° C. and which generally turn to a liquid state when used together with another material fat and/or oil, may also be preferably used. Especially, a canola oil, a mixture of a canola oil and a soybean oil, or the like, which have an advantage of being a liquid oil having a low melting point and excellent oxidative stability, may be preferably used.

The aforementioned typical fat and/or oil for heat cooking preferably constitutes the entire fat and/or oil composition for heat cooking according to the present disclosure, except for a part of the fat and/or oil composition that is composed of the fatty acid monoglyceride, the alkali metal, and other additives, which may be added as needed.

### (Fatty Acid Monoglyceride)

The fat and/or oil composition for heat cooking according to the present disclosure contains the fatty acid monoglyceride. The fatty acid monoglyceride used in the present disclosure is normally obtained by subjecting a glycerol and a fatty acid to thermal esterification and, if necessary, to refining by molecular distillation or the like. Examples of the constituent fatty acid in the fatty acid monoglyceride may include any fatty acid having from 8 to 22 carbon atoms that may be a saturated or unsaturated and linear or branched fatty acid, namely, caprylic acid, capric acid, lauric acid, myristic acid, palmitic acid, palmitoleic acid, stearic acid, behenic acid, isostearic acid, oleic acid, linolic acid, and linolenic acid, as well as ricinoleic acid and 12-hydroxystearic acid having a hydroxyl group in molecules. More preferable examples of constituent fatty acid in the fatty acid monoglyceride may include a fatty acid composed mainly of from 16 to 18 carbon atoms. The constituent fatty acid in the fatty acid monoglyceride may also include a mixed fatty acid of the above fatty acids or a mixed fatty acid derived from, for example, palm oil, rapeseed oil, safflower oil, and soybean oil.

The constituent fatty acid in the fatty acid monoglyceride contains 60 mass % or more of an unsaturated fatty acid having 18 carbon atoms. When the constituent fatty acid in the fatty acid monoglyceride contains 60 mass % or more of the unsaturated fatty acid having 18 carbon atoms, the effect of preventing the coloring of the fat and/or oil composition for heat cooking is further enhanced. Herein, examples of the unsaturated fatty acid having 18 carbon atoms may include oleic acid, linolic acid, and linolenic acid, and oleic acid is more preferable than others.

During synthesis of the fatty acid monoglyceride, sometimes a fatty acid diglyceride, in addition to the fatty acid monoglyceride, may be produced due to reaction between the glycerol and the fatty acid. In the present disclosure, only the fatty acid monoglyceride obtained by refining may be used. However, a mixture of the fatty acid monoglyceride and the fatty acid diglyceride may also be added as it is to the fat and/or oil composition for heat cooking. Alternatively, the fatty acid monoglyceride resulted from the refining and the fatty acid diglyceride resulted from the refining may be added separately to the fat and/or oil composition for heat cooking.

When the fat and/or oil composition for heat cooking according to the present disclosure further contains the fatty acid diglyceride, a mass ratio between the fatty acid monoglyceride and the fatty acid diglyceride (fatty acid monoglyceride:fatty acid diglyceride) is preferably in the range of from 1:1 to 7:3. With the above range, the effect of preventing the coloring of the fat and/or oil composition for heat cooking is further enhanced.

The fatty acid monoglyceride may be prepared by subjecting the glycerol and the fatty acid to thermal esterification under the presence of an alkali catalyst or without a catalyst. Herein, examples of the alkali catalyst may include sodium hydroxide, sodium carbonate, sodium hydrogen carbonate, potassium hydroxide, potassium carbonate, and potassium bicarbonate. Additionally, when the fatty acid monoglyceride is prepared by using the alkali catalyst, the resulting fatty acid monoglyceride normally contains, as a fatty acid salt, a residual alkali metal derived from the alkali catalyst. The fatty acid monoglyceride containing, as the fatty acid salt, the residual alkali metal derived from the alkali catalyst may be used in the fat and/or oil composition for heat cooking according to the present disclosure. In the present disclosure, the fatty acid monoglyceride containing the residual alkali metal derived from the alkali catalyst is considered as one of examples of the “fatty acid monoglyceride containing an alkali metal.”

In the esterification reaction between the glycerol and the fatty acid, the fatty acid is used in an amount preferably of from 2 to 5 times by mol, more preferably of from 2.5 to 4.5 times by mol, the amount of the glycerol. From the perspective of reaction rate and quality, a reaction temperature is preferably from 170 to 260° C., more preferably from 180 to 250° C., and even more preferably from 190 to 230° C. Furthermore, from the perspective of progress of the esterification, a reaction time period is preferably from 5 to 15 hours, more preferably from 6 to 15 hours. The amount of the catalyst used is preferably from 0.01 to 0.5 mass %, more preferably from 0.05 to 0.2 mass %, with respect to a total feed amount. The reaction time period is preferably from 2 to 20 hours, more preferably from 3 to 20 hours. The reason is that the above reaction time period makes a solidification rate slow, thereby allowing preparation of the fatty acid monoglyceride of good-quality. The reaction is normally carried out under normal pressure or reduced pressure. From the perspective of removing produced water, the reaction is preferably carried out under reduced pressure, more preferably under a pressure of 66.6 kPa or less. Furthermore, from the perspectives of preventing the coloring and removing produced water, nitrogen is preferably flown through a reaction system. A nitrogen flow rate is preferably from 10 to 200 mL/min·kg, more preferably from 20 to 100 mL/min·kg.

The resulting esterification product contains the fatty acid monoglyceride, the fatty acid diglyceride, and the fatty acid salt. Although the resulting esterification product may be used as it is, distillation may be conducted to separate the fatty acid monoglyceride, which does not contain the fatty acid salt, for use. The distillation may employ a known method, such as a short-path distillation method. Additionally, the fatty acid diglyceride may also be separated by the distillation.

The content of the fatty acid monoglyceride in the fat and/or oil composition for heat cooking according to the present disclosure is from 0.01 to 1.0 mass %. When the content of the fatty acid monoglyceride is from 0.01 to 1.0 mass %, the effect of preventing the coloring is provided in combination with the alkali metal. Additionally, from the perspective of the effect of preventing the coloring, the content of the fatty acid monoglyceride is preferably from 0.01 to 0.5 mass %, more preferably from 0.01 to 0.2 mass %, and most preferably from 0.01 to 0.15 mass %.

### (Alkali Metal)

The fat and/or oil composition for heat cooking according to the present disclosure contains the alkali metal. The alkali metal is not limited to a specific alkali metal and preferably includes at least one selected from the group consisting of sodium and potassium. The alkali metal may be added as an ingredient containing an alkali metal. Examples of the ingredient containing an alkali metal may include, in addition to the aforementioned fatty acid monoglyceride containing an alkali metal that is produced by using the alkali catalyst, a polyglycerol fatty acid ester containing an alkali metal and a sucrose fatty acid ester containing an alkali metal that are produced by using the alkali catalyst. When the fatty acid monoglyceride containing an alkali metal is used, an alkali metal concentration in the aforementioned fatty acid monoglyceride reaction product is preferably from 10 to 50000 mass ppm. The alkali metal concentration is more preferably from 500 to 2000 mass ppm and even more preferably from 600 to 1000 mass ppm. The alkali metal concentration in such an ingredient containing an alkali metal may be controlled by various methods, including a method of controlling the amount of the alkali catalyst during the production reaction of the fatty acid monoglyceride or the like to control the alkali metal concentration in the reaction product, and a method of adding the fatty acid monoglyceride or the like that does not contain any alkali metal, as needed. In the fat and/or oil composition for heat cooking according to the present disclosure, the fatty acid monoglyceride and the ingredient containing an alkali metal are preferably contained as a fatty acid monoglyceride containing an alkali metal.

Alternatively, as the ingredient containing an alkali metal, a water-soluble or oil-soluble salt, such as a sodium salt and a potassium salt that may be used as a food additive, may also be used. The sodium salt and the potassium salt are not limited to specific salts. Examples of the sodium salt and the potassium salt may include sodium hydroxide, potassium hydroxide, sodium carbonate, potassium carbonate, sodium bicarbonate, potassium bicarbonate, sodium malate, sodium citrate, potassium citrate, sodium L-ascorbate, sodium erythorbate, sodium L-glutamate, sodium succinate, potassium sorbate, casein sodium, sodium DL-tartrate, sodium stearoyl lactylate, fatty acid sodium, and fatty acid potassium. More preferable examples of the sodium salt and the potassium salt may include fatty acid sodium, such as sodium oleate.

The content of the alkali metal in the fat and/or oil composition for heat cooking according to the present disclosure is from 0.1 to 5.0 mass ppm. When the content of the alkali metal is from 0.1 to 5.0 mass ppm, the effect of preventing the coloring is provided in combination with the aforementioned fatty acid monoglyceride. The content of the alkali metal is preferably from 0.1 to 3.0 mass ppm and more preferably from 0.1 to 2.5 mass ppm. The content of the alkali metal may be quantified by atomic absorption spectrophotometry in the state where the ingredient containing an alkali metal as described above is contained in the fat and/or oil composition for heat cooking.

### (Other Ingredients)

Other ingredients, in such amounts that do not ruin the advantageous effects of the present disclosure, may also be added to the fat and/or oil composition for heat cooking according to the present disclosure. Other ingredients include those (such as food additives) that are used in typical fats and oils. Examples of these ingredients may include an anti-oxidizing agent, an emulsifying agent other than the fatty acid monoglyceride, a silicone oil, a crystal regulator, and an oral sensation improving agent. These ingredients are preferably added sometime after deodorization and before packing. Additionally, an ingredient, such as a phospholipid, that triggers the coloring in response to heating is preferably added only within a range in which the coloring is prevented. For example, the amount of the phospholipid to be added or the content of the phospholipid is preferably less than 0.01 mass %.

Examples of the anti-oxidizing agent may include tocopherols, ascorbic acids, a flavone derivative, a kojic acid, a gallic acid derivative, a catechin and an ester thereof, a fukiic acid, gossypol, sesamol, and terpenes. As other examples of the emulsifying agent than the fatty acid monoglyceride, any of a sucrose fatty acid ester, a sorbitan fatty acid ester, a polysorbate, a propylene glycol fatty acid ester, a polyglycerol condensed ricinoleate, diacylglycerol, waxes, sterol esters, and a phospholipid may be selected as appropriate.

Examples of the silicone oil may include those commercially available for food use and may include but not particularly limited to those having a dimethylpolysiloxane structure and having a kinetic viscosity at 25° C. of from 800 to 5000 mm²/s. The kinetic viscosity of the silicone oil is, for example, preferably from 800 to 2000 mm²/s and more preferably from 900 to 1100 mm²/s. The term kinetic viscosity herein refers to a value measured in conformity with JIS K 2283(2000). The silicone oil may contain, in addition to the silicone oil, particulate silica.

<Intended Use of Fat and/or Oil Composition for Heat Cooking>

The fat and/or oil composition for heat cooking according to the present disclosure may be suitable for any intended use in heat cooking. However, since being capable of preventing the coloring caused by heating and preventing the deterioration caused by heating efficiently, the fat and/or oil composition for heat cooking according to the present disclosure is preferably used for frying, that is to say, used as a frying fat and/or oil. The reason is that a frying fat and/or oil is often used under harsh conditions, such as a high temperature, heating for a long time period, and a repeated use, compared with a fat and/or oil with other intended uses in heat cooking. Accordingly, it is especially required for the fat and/or oil composition used for fry cooking to be capable of preventing the deterioration caused by heating.

<Method of Preparing Fat and/or Oil Composition for Heat Cooking>

A fat and/or oil used in the method of preparing a fat and/or oil composition for heat cooking according to the present disclosure is prepared by using, as a starting material, a raw oil extracted from a plant seed, a fruit, or an animal material, similarly to a typical fat and/or oil. The method of preparing a fat and/or oil composition includes, if necessary, a degumming process, a deoxidization process, and a decolorizing process in the stated order. Then, if necessary, a dewaxing process follows, and after that, a deodorization process and the subsequent refining process are performed. The above processes may be used to prepare the fat and/or oil composition. The degumming process, the deoxidization process, and the dewaxing process may be appropriately adopted in accordance with the quality of the raw oil that may vary according to a fat and/or oil material from which the raw oil is extracted.

In addition to the aforementioned refining process of the fat and/or oil, the preparation method according to the present disclosure further includes a process of adding, to the refined fat and/or oil, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil composition for heat cooking. Adding the fatty acid monoglyceride preferably includes adding and dissolving the fatty acid monoglyceride into the fat and/or oil that has been heated after the refining process. As the ingredient containing an alkali metal, as described earlier, any of the fatty acid monoglyceride containing an alkali metal, the polyglycerol fatty acid ester containing an alkali metal, and the sucrose fatty acid ester containing an alkali metal may be used. As the ingredient containing an alkali metal, as described earlier, the alkali metal salt may also be used. When the alkali metal salt is used, the alkali metal salt may be dissolved in a little amount of a solvent (water or the refined fat and/or oil) to form an alkali metal salt solution. Then, as needed, the formed alkali metal salt solution may be mixed with the emulsifying agent, such as fatty acid monoglyceride, the polyglycerol fatty acid ester, the sucrose fatty acid ester, and the monoglyceride, before being added to a large amount of the refined fat and/or oil. Additionally, as an ingredient containing both the “fatty acid monoglyceride” and the “ingredient containing an alkali metal” to be added, a fatty acid monoglyceride containing an alkali metal may be used.

A constituent fatty acid in the fatty acid monoglyceride contains 60 mass % or more of an unsaturated fatty acid having 18 carbon atoms. When the constituent fatty acid in the fatty acid monoglyceride contains 60 mass % or more of an unsaturated fatty acid having 18 carbon atoms, the effect of preventing the coloring of the fat and/or oil composition for heat cooking is further enhanced. Herein, examples of the unsaturated fatty acid having 18 carbon atoms are as described above.

As described earlier, during synthesis of the fatty acid monoglyceride, sometimes a fatty acid diglyceride, in addition to the fatty acid monoglyceride, may be produced due to reaction between the glycerol and the fatty acid. In the present disclosure, only the fatty acid monoglyceride obtained by refining may be added to the refined fat and/or oil. However, a mixture of the fatty acid monoglyceride and the fatty acid diglyceride may also be added as it is to the refined fat and/or oil. Alternatively, the fatty acid monoglyceride resulted from the refining and the fatty acid diglyceride resulted from the refining may be added separately to the refined fat and/or oil.

When the fatty acid diglyceride is additionally added to the refined fat and/or oil, a mass ratio between the fatty acid monoglyceride and the fatty acid diglyceride (fatty acid monoglyceride:fatty acid diglyceride) is preferably in the range of from 1:1 to 7:3. With the above range, the effect of preventing the coloring of the fat and/or oil composition for heat cooking is further enhanced.

After the fatty acid monoglyceride and the ingredient containing an alkali metal are added, the fatty acid monoglyceride and the alkali metal are dissolved or dispersed uniformly in the refined fat and/or oil by, for example, stirring. Subsequently, a dehydration process may be performed if necessary. The dehydration is preferably performed under reduced pressure at approximately from 70 to 105° C. When the fatty acid monoglyceride and the alkali metal are mixed with the emulsifying agent before being added to the refined oil, the mixing process with the emulsifying agent and the dehydration process may be performed before they are added to the refined fat and/or oil.

The preparation method according to the present disclosure may also include a process of adding other additives, as needed. The process of adding other additives is preferably performed after the fat and/or oil has undergone the refining process, and conditions, such as a temperature of the fat and/or oil, during the adding process may be appropriately selected depending on what additives are used and why the additives are added.

<Method of Preventing Deterioration of Fat and/or Oil for Heat Cooking that is Caused by Heating>

A method of preventing deterioration of a fat and/or oil for heat cooking that is caused by heating includes adding, to the fat and/or oil for heat cooking, a monoglyceride and an ingredient containing an alkali metal to yield the content of the fatty acid monoglyceride of from 0.01 to 1.0 mass % and the content of the alkali metal of from 0.1 to 5.0 mass ppm in the fat and/or oil for heat cooking. Any typical fat and/or oil for heat cooking as described above may be used as the fat and/or oil for heat cooking. Examples of the fatty acid monoglyceride, the ingredient containing an alkali metal, and the alkali metal are as described above.

As a method of adding, to the fat and/or oil for heat cooking, the fatty acid monoglyceride and the ingredient containing an alkali metal, the process of adding the fatty acid monoglyceride and the ingredient containing an alkali metal according to the aforementioned method of preparing a fat and/or oil composition for heat cooking according to the present disclosure may be used. The fat and/or oil for heat cooking to which the fatty acid monoglyceride and the ingredient containing an alkali metal are added may be any of the aforementioned refined fat and/or oil, a fat and/or oil containing other additives, and a fat and/or oil containing a fatty acid monoglyceride and an alkali metal in advance. The fat and/or oil for heat cooking may be unused or already used for cooking. Additionally, as an ingredient containing both the “fatty acid monoglyceride” and the “ingredient containing an alkali metal” to be added, a fatty acid monoglyceride containing an alkali metal may be used.

A constituent fatty acid in the fatty acid monoglyceride contains 60 mass % or more of an unsaturated fatty acid having 18 carbon atoms. When the constituent fatty acid in the fatty acid monoglyceride contains 60 mass % or more of an unsaturated fatty acid having 18 carbon atoms, the effect of preventing the coloring of the fat and/or oil for heat cooking is further enhanced. Herein, examples of the unsaturated fatty acid having 18 carbon atoms are as described above.

As described earlier, during synthesis of the fatty acid monoglyceride, sometimes a fatty acid diglyceride, in addition to the fatty acid monoglyceride, may be produced due to reaction between the glycerol and the fatty acid. In the present disclosure, only the fatty acid monoglyceride obtained by refining may be added to the fat and/or oil for heat cooking. However, a mixture of the fatty acid monoglyceride and the fatty acid diglyceride may also be added as it is to the fat and/or oil for heat cooking. Alternatively, the fatty acid monoglyceride resulted from the refining and the fatty acid diglyceride resulted from the refining may be added separately to the fat and/or oil for heat cooking.

When the fatty acid diglyceride is additionally added to fat and/or oil for heat cooking, a mass ratio between the fatty acid monoglyceride and the fatty acid diglyceride (fatty acid monoglyceride:fatty acid diglyceride) is preferably in the range of from 1:1 to 7:3. With the above range, the effect of preventing the coloring of the fat and/or oil for heat cooking is further enhanced.

### EXAMPLES

Hereinafter, the present disclosure will be described concretely based on Examples. However, the present disclosure is not limited to these Examples.

### <Preparation of Fatty Acid Monoglyceride Composition>

A fatty acid (containing 78 mass % of an oleic acid, 2 mass % of a stearic acid, 11.3 mass % of a linolic acid, and 2.3 mass % of a palmitic acid) and a glycerol were subject to esterification (1) without using a catalyst, (2) under the presence of sodium hydroxide, or (3) under the presence of potassium hydroxide. By doing so, fatty acid monoglyceride compositions 1 to 3 with compositions illustrated in Table 1 were obtained.

Additionally, the content of a fatty acid monoglyceride, the content of a fatty acid diglyceride, and the content of the glycerol in each composition were measured by gas chromatograph. The content of an alkali metal (sodium and/or potassium) was measured by an atomic absorption spectrophotometer (Z2310 manufactured by Hitachi High-Technologies Corporation).

TABLE 1

| | | Fatty acid | Fatty acid | Fatty acid |
|---|---|---|---|---|
| | | monoglyceride | monoglyceride | monoglyceride |
| | | composition 1 | composition 2 | composition 3 |
| Catalyst | | Without catalyst | Sodium | Potassium |
| | | | hydroxide | hydroxide |
| Composition | Content of fatty | Approximately | Approximately | Approximately |
| | acid monoglyceride | 60 mass % | 60 mass % | 60 mass % |
| | Content of fatty | Approximately | Approximately | Approximately |
| | acid diglyceride | 30 mass % | 30 mass % | 30 mass % |
| | Content of glycerol | Approximately | Approximately | Approximately |
| | | 10 mass % | 10 mass % | 10 mass % |
| | Content of Na | — | 940 mass ppm | — |
| | Content of K | — | — | 840 mass ppm |

### <Preparation of Metal-Containing PGPR>

A ricinoleic acid was condensed to obtain a condensed ricinoleic acid. The obtained condensed ricinoleic acid and a hexaglycerol were subjected to esterification under the presence of sodium hydroxide to obtain a PGPR composition 1, in which the content of Na was 970 mass ppm and the content of a hexaglycerol condensed ricinoleate (PGPR) was 70 mass %.

Furthermore, the condensed ricinoleic acid obtained as above and hexaglycerol were subjected to esterification under the presence of potassium hydroxide to obtain a PGPR composition 2, in which the content of K was 920 mass ppm and the content of the hexaglycerol condensed ricinoleate (PGPR) was 70 mass %.

Additionally, the content of PGPR in each composition was measured by gas chromatograph, and the content of the alkali metal (sodium and/or potassium) was measured by the atomic absorption spectrophotometer (Z2310 manufactured by Hitachi High-Technologies Corporation).

### <Preparation of Test Oils>

The fatty acid monoglyceride compositions 1 to 3 or the PGPR compositions 1 and 2 obtained as above were each added to a fat and/or oil and mixed until it was uniform. As the fat and/or oil, Nisshin canola oil (manufactured by Nisshin Oillio Group, Ltd.) was used. Thus, test oils (fat and/or oil compositions) were prepared. For each of the obtained test oils, frying tests were conducted according to the following methods. Subsequently, color values (Y+10R) of the test oils were evaluated.

For comparison, for the fat and/or oil only, the frying tests were also conducted. Subsequently, the color value (Y+10R) of the fat and/or oil was evaluated (refer to Comparative Example 1). Table 2 illustrates results of the evaluations.

### <Frying Tests>

Into respective friers, 4L of test oils (fat and/or oil compositions) were poured to fry sweet potato fries (for from 0 to 16 hours), croquettes (for from 17 to 32 hours), and karaage (for from 33 to 80 hours) according to the following procedures.

### (Sweet Potato Fries)

Every hour, 8 sliced sweet potato pieces each having a thickness of 1 cm and coated with batter, in which Nisshin Oishii Tempura Powder (manufactured by Nisshin Foods Inc.):water=1:1.5, were fried for 3.5 minutes (at 180° C.).

### (Croquettes)

Every hour, 4 Nichirei Koromo-Ga Sakusaku-No Croquettes (with vegetables) (manufactured by Nichirei Foods Inc.) were fried for 4 minutes (at 180° C.).

### (Karaage)

Every hour, 6 pieces of 35 g chicken thigh, coated with batter, in which Karaage-No Moto No.1 (manufactured by Nihon Shokken Holdings Co., Ltd.): water=1:1, were fried for 4 minutes.

<Evaluation of Color values (Y+10R)>

After the frying tests (80 hours), the yellowness (Y) and the redness (R) of each of the test oils were scaled by a Lovibond colorimeter (Lovibond PFX995, manufactured by the Tintometer Limited) employing a cell with a cell length of ½ inches (12.7 mm). Then, for each test oil, the color value (Y+10R) as an index reflecting the degree of the coloring by appearance was calculated for evaluation. The smaller the color value (Y+10R) is, the less the degree of the coloring by appearance is, and the less intense the coloring is.

Additionally, for each test oil, the degree of the coloring before the frying tests (0 hour) was also evaluated for confirmation.

TABLE 2

| | | Comparative | Comparative | | | | | Comparative | Comparative |
|---|---|---|---|---|---|---|---|---|---|
| | | Example 1 | Example 2 | Example 1 | Example 2 | Example 3 | Example 4 | Example 3 | Example 4 |
| Composition | Canola oil | 100 | 99.8 | 99.79 | 99.76 | 99.8 | 99.98 | 99.79 | 99.78 |
| | | mass % | mass % | mass % | mass % | mass % | mass % | mass % | mass % |
| | Fatty acid | — | 0.2 | — | — | 0.18 | — | — | — |
| | monoglyceride | | mass % | | | mass % | | | |
| | composition 1 | | | | | | | | |
| | Fatty acid | — | — | 0.21 | — | 0.02 | 0.02 | — | — |
| | monoglyceride | | | mass % | | mass % | mass % | | |
| | composition 2 | | | | | | | | |
| | Fatty acid | — | — | — | 0.24 | — | — | — | — |
| | monoglyceride | | | | mass % | | | | |
| | composition 3 | | | | | | | | |
| | PGPR | — | — | — | — | — | — | 0.21 | — |
| | composition 1 | | | | | | | mass % | |
| | PGPR | — | — | — | — | — | — | — | 0.22 |
| | composition 2 | | | | | | | | mass % |
| Content of fatty acid monoglyceride | | — | 0.12 | 0.13 | 0.14 | 0.12 | 0.01 | — | — |
| | | | mass % | mass % | mass % | mass % | mass % | | |
| Content of Na | | — | — | 2 | — | 0.2 | 0.2 | 2 | — |
| | | | | mass ppm | | mass ppm | mass ppm | mass ppm | |
| Content of K | | — | — | — | 2 | — | — | — | 2 |
| | | | | | mass ppm | | | | mass ppm |
| Evaluation | Color value | 0.4 | 0.4 | 0.4 | 0.4 | 0.4 | 0.4 | 0.4 | 0.4 |
| | (Y + 10R): | | | | | | | | |
| | 0 hour | | | | | | | | |
| | Color value | 86.0 | 84.0 | 76.0 | 73.0 | 74.0 | 75.0 | 80.0 | 85.0 |
| | (Y + 10R): | | | | | | | | |
| | 80 hours | | | | | | | | |

The test oils according to Examples 1 to 4 prevent the coloring much more than the test oil according to Comparative Example 1, which is composed of the fat and/or oil.

On the other hand, the test oil according to Comparative Example 2, which contains the fatty acid monoglyceride but does not contain any alkali metal, prevents the coloring less than the test oil according to Comparative Example 1, which is composed of the fat and/or oil.

Furthermore, the test oils according to Comparative Examples 3 and 4, which each contain, as the alkali metal, an alkali metal salt of the hexaglycerol condensed ricinoleate (PGPR) but do not contain any fatty acid monoglyceride, prevent the coloring less than Comparative Example 1, which is composed of the fat and/or oil.

### INDUSTRIAL APPLICABILITY

A fat and/or oil composition for heat cooking according to the present disclosure may be used in the field of food manufacturing preferably as a frying fat and/or oil employed in manufacture of fried foods. A fat and/or oil composition for heat cooking according to the present disclosure may also be used in manufacture of any other foods requiring a fat and/or oil for heat cooking.

1. A fat and/or oil composition for heat cooking, the fat and/or oil composition comprising:
a fat and/or oil; a fatty acid monoglyceride; and an alkali metal, wherein
a content of the fatty acid monoglyceride is from 0.01 to 1.0 mass %, and
a content of the alkali metal is from 0.1 to 5.0 mass ppm.

2. The fat and/or oil composition for heat cooking according to claim 1, wherein a constituent fatty acid in the fatty acid monoglyceride contains 60 mass % or more of an unsaturated fatty acid having 18 carbon atoms.

3. The fat and/or oil composition for heat cooking according to claim 1, the fat and/or oil composition further comprising:
a fatty acid diglyceride, wherein
a mass ratio between the fatty acid monoglyceride and the fatty acid diglyceride is from 1:1 to 7:3.

4. The fat and/or oil composition for heat cooking according to claim 1, wherein the fat and/or oil composition is for use in frying.

5. The fat and/or oil composition for heat cooking according to claim 1, wherein the fat and/or oil composition is used in frying to prevent coloring caused by heating.

6. A method of preparing a fat and/or oil composition for heat cooking, the method comprising:
refining a fat and/or oil, and subsequently adding, to the refined fat and/or oil, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil composition.

7. The method according to claim 6, wherein a constituent fatty acid in the fatty acid monoglyceride contains 60 mass % or more of an unsaturated fatty acid having 18 carbon atoms.

8. The method according to claim 6, the method further comprising:
adding a fatty acid diglyceride to the refined fat and/or oil, wherein
a mass ratio between the fatty acid monoglyceride and the fatty acid diglyceride is from 1:1 to 7:3.

9. The method according to claim 6, wherein, as an ingredient containing both the fatty acid monoglyceride and the ingredient containing an alkali metal, a fatty acid monoglyceride containing an alkali metal is used.

10. A method of preventing deterioration of a fat and/or oil for heat cooking that is caused by heating, the method comprising:
adding, to the fat and/or oil for heat cooking, a fatty acid monoglyceride and an ingredient containing an alkali metal to yield a content of the fatty acid monoglyceride of from 0.01 to 1.0 mass % and a content of the alkali metal of from 0.1 to 5.0 mass ppm in the fat and/or oil for heat cooking.

11. The method according to claim 10, wherein a constituent fatty acid in the fatty acid monoglyceride contains 60 mass % or more of an unsaturated fatty acid having 18 carbon atoms.

12. The method according to claim 10, the method further comprising:
adding a fatty acid diglyceride to the fat and/or oil for heat cooking, wherein
a mass ratio between the fatty acid monoglyceride and the fatty acid diglyceride is from 1:1 to 7:3.

13. The method according to claim 10, wherein, as an ingredient containing both the fatty acid monoglyceride and the ingredient containing an alkali metal, a fatty acid monoglyceride containing an alkali metal is used.
